(19) United States
(12) Patent Application Publication
(10) Pub. No.: US 2001/0023375 A1
(43) Pub. Date: Sep. 20, 2001

(54) Fingerprint hard disk

(75) Inventor: Ning Shen, Hangzhou (CN)

Correspondence Address: MERCHANT & GOULD PC, P.O. BOX 2903, MINNEAPOLIS, MN, 55402-0903, US

(73) Assignee: Miaxis Biometrics Co.

(21) Appl. No.: 09/810,844

(22) Filed: Mar. 16, 2001

(30) Foreign Application Priority Data
Mar. 17, 2000 (CN) 00104622.5

(51) Int. Cl. G05B 15/00

(52) U.S. Cl. 700/83

(57) ABSTRACT

A fingerprint hard disk has been provided in the present invention. Said fingerprint hard disk comprises a fingerprint identifier for identifying whether the user's fingerprint is qualified, wherein said fingerprint identifier includes a control interface for issuing a control signal according to the identification result of the fingerprint identifier; and comprises a hard disk including a hard disk body and a hard disk control device which is used to receive a control signal issued by the control interface of the fingerprint identifier to control the operating state of the hard disk body. The fingerprint identifier and the hard disk are combined organically; and the fingerprint of a specific user may be recorded in advance as required, and then, by identifying the fingerprint, only said specific user will be allowed to open the hard disk and read the data.

### FIELD OF THE INVENTION

The present invention relates to a computer hard disk, more particularly, to a fingerprint hard disk used by a computer.

### BACKGROUND OF THE ART

Following the wide application of computers, the information security of computers is more and more concerned. At present, most security methods used for computers are setting their own ciphers. A switch-on password or switch-on registration should be input during the start-up period so as to only allow a user who knows the cipher to access information stored in the computer. However, because all of these methods are used only for setting the obstacles for switching on the computers and no encryption step is set for the hard disk in which a large number of the data information is stored, if the hard disk in which the information is stored is removed and installed in other computers, then the data can be read easily thereby the security problem can not be solved thoroughly.

### SUMMARY OF THE INVENTION

An object of the present invention is to aim at the problems existing in the above art and to provide a fingerprint hardware used for securing the data information by incorporating organically a fingerprint identifier with the original hardware.

To realize the above object, a kind of the fingerprint hard disk is provided in the present invention, said fingerprint hard disk comprises a fingerprint identifier for identifying whether the user's fingerprint is qualified; a control interface for outputting a control signal according to an identification result of the fingerprint identifier; and a hard disk including a hard disk body and hard disk control device, wherein the control signal output from the control interface of the fingerprint identifier may be received and the operating state of the hard disk body may be controlled by the hard disk control device.

In a preferred embodiment, the hard disk control device is a hard disk control port.

In another preferred embodiment, the hard disk control device is an electric controlled switch. A power supply interface and a signal interface are also included in the hard disk. The control interface of the fingerprint identifier and the power supply interface of the hard disk both are connected with the hard disk body through the electric controlled switch.

In a further preferred embodiment, the hard disk control device is an electric controlled switch. A power supply interface and a signal interface are also included in the hard disk. The control interface of the fingerprint identifier and the signal interface of the hard disk both are connected with the hard disk body through the electric controlled switch.

In another preferred embodiment, the hard disk control device is an electric controlled switch. A disk cavity and a control board are also included in the hard disk body, wherein the disk cavity is connected to the control board through a magnetic head signal wire, a step motor control wire, and a rotation motor control wire. The control interface of the fingerprint identifier is connected to the magnetic head signal wire, the step motor control wire, and the rotation motor control wire through the electric controlled switch.

In a further preferred embodiment, a control board is involved inside each of the fingerprint identifier and the hard disk respectively. A microprocessor, an interface circuit and a RAM are shared by both control boards, and whether to enable the hard disk control procedure that controls the operation of the hard disk device will be determined by the fingerprint identification procedure operated by the fingerprint identifier according to the decision result; or whether to enable the operation of the hard disk will be determined by the hard disk control procedure operated by the hard disk control device according to the decision result of the fingerprint identification procedure. More specifically, the control board uses fingerprint biometric authentication module to prevent unauthorized users from booting hard disc. Computers with this control board will not load the operating system from the hard drive without authenticating the user's fingerprint. This control board can also be used to protect an encrypted disk through the ATA-3 protocol. This prevents unauthorized access to the hard drive even if it is removed from the computer in an attempt to bypass this control board authentication. Fingerprint authentication module is stored with the user data in the control board. The main process of this module is that first, the initial registration “template” of the user's fingerprint has to be constructed. This is done by collecting a number of samples through whatever sensor device being used. Salient features are extracted from the samples, and the results combined into the template. This initial template is then stored by the application, and essentially takes the place of a password. Thereafter, whenever the user needs to be authenticated, live samples are captured from the sensor, processed into a usable form, and matched against the template that was enrolled earlier. These enrollment and match process all worked in control board.

Furthermore, in the fingerprint hard disk of the present invention, a relay or an electronic switch may be used as the electric controlled switch. The hard disk may be a portable hard disk, a flash disk, Zip drive disk or other storage devices.

At present, the hard disk, which forms a part of the computer hardware, is a fully developed product. Also, there is a long history for producing the fingerprint identifier, which is a very useful commercial product. According to the present invention, a fingerprint identifier is incorporated organically with a hard disk, and the fingerprint of a specific user is recorded in advance as required, then opening the hard disk and reading the data can only be carried out by the specific user through the identification of the fingerprint. The problems involved in the conventional security method, which only solves a part but not all of the problems, are overcome by the implementation of such technique scheme, thereby the data stored in the hard disk can be secured. Because the carrier of the computer information is mainly the hard disk, therefore the security problem of the computer information has been solved essentially in the present invention.

### BRIEF DESCRIPTION OF THE DRAWINGS

The present invention will be described in detail as follows when taken in conjunction with the drawings, wherein:

FIG. 1 is a schematic diagram of the structure of the fingerprint hard disk in accordance with the first embodiment of the present invention;

FIG. 2 is a schematic diagram of the structure of the fingerprint hard disk in accordance with the second embodiment of the present invention;

FIG. 3 is a schematic diagram of the structure of the fingerprint hard disk in accordance with the third embodiment of the present invention;

FIG. 4 is a schematic diagram of the structure of the fingerprint hard disk in accordance with the fourth embodiment of the present invention;

FIG. 5 is a schematic diagram of the structure of the fingerprint hard disk in accordance with the fifth embodiment of the present invention;

FIG. 6 is a schematic diagram of the structure of the fingerprint hard disk in accordance with the sixth embodiment of the present invention.

### PREFERRED EMBODIMENTS OF THE INVENTION

Embodiment 1

The fingerprint hard disk 1 in accordance with the first embodiment of the present invention is shown in FIG. 1. A fingerprint identifier 10 and a hard disk 20 are included in the fingerprint hard disk 1. The fingerprint identifier 10 may be used for identifying whether the user's fingerprint is qualified, then other equipment can be controlled through a control interface 12 based on the result of the decision. In the hard disk 20, a hard disk body 22 is connected to the external equipment via a power supply interface 24 and a signal interface 26. Power supply is supplied to the hard disk body 22 by the power supply interface 24, and the signal interface 26 is used for enabling the information exchange between the hard disk body 22 and the computer or other equipment. An electric controlled switch 28, which is connected between the hard disk body 22 and the power supply interface 24 and is connected with the control interface 12 of the fingerprint identifier 10 as well, is also included in the hard disk 20. The electric controlled switch 28 may be a relay, an electronic switch, or other electric controlled switch. The connection between the hard disk body 22 and the power supply interface 24 can be connected/disconnected by the control interface 12 of the fingerprint identifier 10 by controlling the electric controlled switch 28. When the user's fingerprint is qualified, a close instruction will be issued by the control interface 12 of the fingerprint identifier 10 to the electric controlled switch 28. The electric controlled switch 28 will be closed, and the power may be supplied from the external power supply to the hard disk body 22, so that the hard disk body 22 is allowed to operate. When the user's fingerprint is not qualified, an open instruction will be issued by the control interface 12 of the fingerprint identifier 10 to the electric controlled switch 28. The electric controlled switch 28 will be opened, and the connection between the external power supply and the hard disk body 22 may be disconnected, so that the hard disk body 22 is not allowed to operate.

Embodiment 2

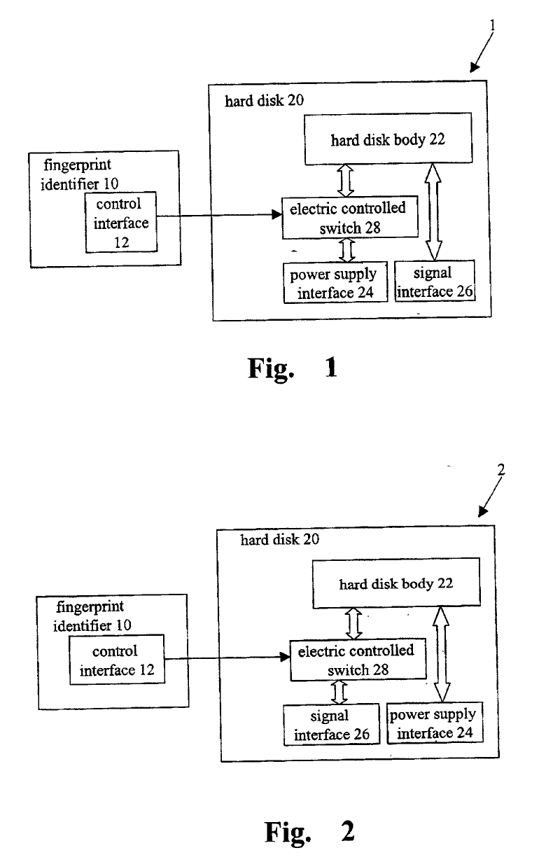

The fingerprint hard disk 2 in accordance with the second embodiment of the present invention is shown in FIG. 2. As similar to the fingerprint hard disk 1 of the first embodiment, a fingerprint identifier 10 and a hard disk 20 are included in the fingerprint hard disk 2. Other equipment can be controlled by the fingerprint identifier 10 through a control interface 12 based on the identification result. In the hard disk 20, a hard disk body 22 is connected to the external equipment via a power supply interface 24 and a signal interface 26. An electric controlled switch 28 is also included in the hard disk 20. But it is different from the first embodiment that the electric controlled switch 28 is connected between the hard disk body 22 and the signal interface 26, and also connected with the control interface 12 of the fingerprint identifier 10. The connection between the hard disk body 22 and the signal interface 26 can be connected/disconnected by the control interface 12 of the fingerprint identifier 10 by controlling the electric controlled switch 28. When the user's fingerprint is qualified, a close instruction will be issued by the control interface 12 of the fingerprint identifier 10 to the electric controlled switch 28. The electric controlled switch 28 will be closed, and the hard disk body 22 may be connected with the signal interface 26, so that the hard disk body 22 is allowed to operate. When the user's fingerprint is not qualified, an open instruction will be issued by the control interface 12 of the fingerprint identifier 10 to the electric controlled switch 28. The electric controlled switch 28 will be opened, and the connection between the signal interface 26 and the hard disk body 22 will be disconnected, so that the hard disk body 22 is not allowed to operate.

Embodiment 3-5

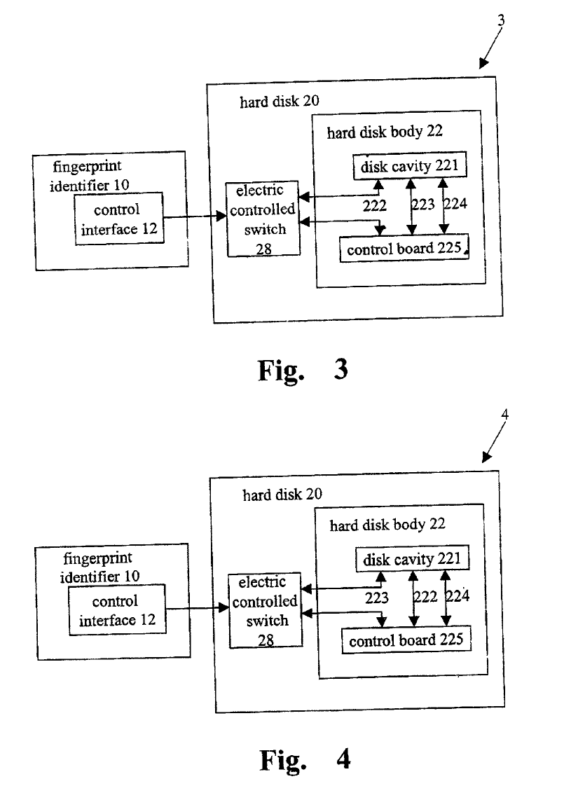

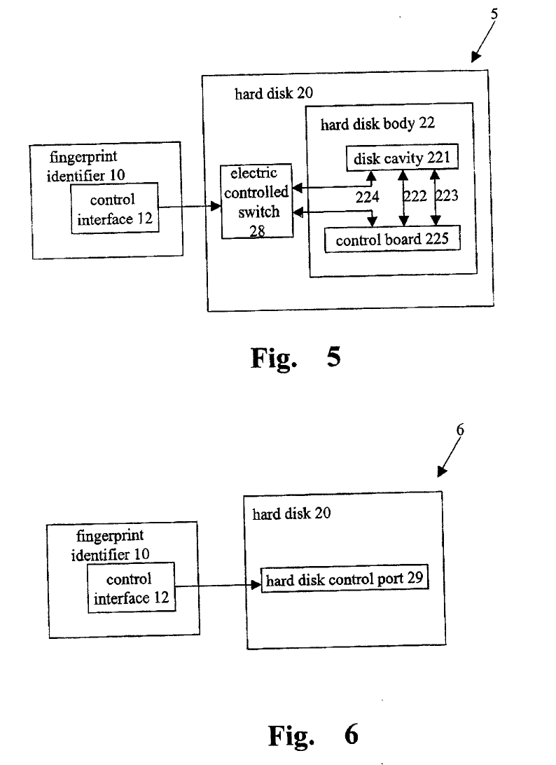

The fingerprint hard disk in accordance with the third to fifth embodiment of the present invention is shown respectively in FIGS. 3-5. A fingerprint identifier 10 and a hard disk 20 are included in the fingerprint hard disk 3 of the third embodiment. The fingerprint identifier 10 can be used for identifying whether the user's fingerprint is qualified, then other equipment can be controlled through a control interface 12 based on the result of the decision. The hard disk body 22 in the hard disk 20 may be divided into two parts including a disk cavity 221 and a control board 225. Signal connection wires, such as the magnetic head signal wire 222, step motor control wire 223, and rotary motor control wire 224, are used for connecting the above two parts. An electric controlled switch 28 is also included in the hard disk 20. The disk cavity 221 and the control board 225 are connected by the magnetic head signal wire, 222 through the electric controlled switch 28. Also, the electric controlled switch 28 is connected with the control interface 12 of the fingerprint identifier 10. As same as the first embodiment and the second embodiment, the electric controlled switch 28 may be a relay, an electronic switch, or other electric controlled switch. The magnetic head signal wire 222 can be connected/disconnected by the control interface 12 of the fingerprint identifier 10 by controlling the electric controlled switch 28. When the user's fingerprint is qualified, a close instruction will be issued by the control interface 12 of the fingerprint identifier 10 to the electric controlled switch 28. The electric controlled switch 28 will be closed, and the magnetic head signal wire 222 will be connected, so that the control board 225 may be connected with the disk cavity 221, and the hard disk body 22 is allowed to operate normally. When the user's fingerprint is not qualified, an open instruction will be issued by the control interface 12 of the fingerprint identifier 10 to the electric controlled switch 28. The electric controlled switch 28 will be opened, and the magnetic head signal wire 222 is disconnected, so that the connection between the control board 225 and the disk cavity 221 will be broken, and the hard disk body 22 is not allowed to operate.

The case of the fourth embodiment and the fifth embodiment is as same as the third embodiment, the only difference between them is that the electric controlled switch 28 is connected to the step motor control wire 223 in the fourth embodiment. The step motor control wire 223 may be connected/disconnected by the control interface 12 of the fingerprint identifier 10 by controlling the electric controlled switch 28, so that the operating or not operating of the hard disk body 22 can be controlled.

Embodiment 6

The fingerprint hard disk 6 in accordance with the sixth embodiment of the present invention is shown in FIG. 6. A fingerprint identifier 10 and a hard disk 20 are included in the fingerprint hard disk 6. The fingerprint identifier 10 may be used for identifying whether the user's fingerprint is qualified, then other equipment can be controlled through a control interface 12 based on the result of the decision. A hard disk control port 29, with which the control interface 5 of the fingerprint identifier 10 is connected, will be added to a hard disk, which is based on the conventional hard disk. When the user's fingerprint is qualified, an operation enable instruction will be issued by the fingerprint identifier 10 through its control interface 12 to the hard disk control port 29 of the hard disk 20. The hard disk 20 will enter a normal operating state on the basis of an operation enable instruction received by the hard disk control port 29. When the user's fingerprint is not qualified, an operation disable instruction will be issued by the fingerprint identifier 10 through the control interface 12 to the hard disk control port 29 of the hard disk 20. The hard disk 20 will not enter the operating state on the basis of the operation disable instruction received by the hard disk control port 29. Thus, in the present embodiment, whether it will operate or not is decided by the hard disk 20 on the basis of the control signal received by the hard disk control port 29 from the control interface 12 of the fingerprint identifier 10.

Embodiment 7

A control board is included inside each of the fingerprint identifier and hard disk; and a microprecessor, an interface circuit, a RAM, and other circuits are included in each control board. In the present embodiment, it is disclosed by the inventor that part of the hardware is shared by the fingerprint identifier 10 and the hard disk 20, and both the fingerprint identification procedure and the hard disk control procedure are combined in one. Specifically, for example, the control board inside the hard disk 20 is consisted of the following parts: a microprocessor b, an interface circuit c, a RAM d, and other circuits e. The control board inside the fingerprint identifier 10 is consisted of the following parts: a microprocessor bb, an interface circuit cc, a RAM dd, and other circuits ee. In the present embodiment, the identical parts of the control board within the hard disk 20 and the control board within the fingerprint identifier 10 are combined, so that the fingerprint hard disk of the present embodiment is constructed to include: a microprocessor b, an interface circuit c, a RAM d, other hard disk circuits e and other fingerprint circuits ee. Therefore, in the present embodiment, the fingerprint identification procedure may be operated by the fingerprint identifier 10 in the fingerprint hard disk through the control board to produce the identification result. Because the fingerprint identification procedure and the hard disk control procedure are combined in one, the identification result of the fingerprint identification procedure will be exchanged internally, whether the hard disk 20 may work or not will be determined by the hard disk control procedure running by the hard disk control device in the hard disk on the basis of the result of the decision. Thus, in the present embodiment, whether to enable the hard disk control procedure is determined by the fingerprint identification procedure on the basis of the result of the decision, and finally, whether the hard disk may work or not can be controlled. Or, whether the hard disk may work or not can be determined by the hard disk control procedure on the basis of the decision result of the fingerprint identification procedure.

Furthermore, an encryption procedure may be added to the hard disk control procedure for encrypting the data written into the disk cavity the data security of the fingerprint hard disk can be realized more perfectly.

In this embodiment, the control board uses fingerprint biometric authentication module to prevent unauthorized users from booting hard disc. Computers with this control board will not load the operating system from the hard drive without authenticating the user's fingerprint. This control board can also be, used to protect an encrypted disk through the ATA-3 protocol. This prevents unauthorized access to the hard drive even if it is removed from the computer in an attempt to bypass this control board authentication. Fingerprint authentication module is stored with the user data in the control board. The main process of this module is that first, the initial registration “template” of the user's fingerprint has to be constructed. This is done by collecting a number of samples through whatever sensor device being used. Salient features are extracted from the samples, and the results combined into the template. This initial template is then stored by the application, and essentially takes the place of a password. Thereafter, whenever the user needs to be authenticated, live samples are captured from the sensor, processed into a usable form, and matched against the template that was enrolled earlier. These enrollment and match process all worked in control board.

In all the previous embodiments, the hard disk may be a portable hard disk, a flash disk, a Zip drive disk or other storage devices.

The present invention has been described previously through the specific embodiments. But, it will be readily apparent to those skilled in the art that various modifications and changes to these embodiments can be made without departing from the spit and scope of the present invention. The protection scope of the present invention will only be limited by the appended claim.

What is claimed:

1. A fingerprint hard disk, wherein, said fingerprint hard disk comprising:
a fingerprint identifier for identifying whether the user's fingerprint is qualified; and comprising a control interface, a control signal will be issued by said control interface according to the identification result of the fingerprint identifier;
a hard disk comprising a hard disk body and a hard disk control device which is used to receive said control signal issued by said control interface of said fingerprint identifier to control the operation state of said hard disk body.

2. A fingerprint hard disk according to claim 1, wherein said hard disk control device is a hard disk control port.

3. A fingerprint hard disk according to claim 1, wherein said hard disk control device is an electric controlled switch; and said hard disk further comprises a power supply interface and a signal interface; wherein said control interface of said fingerprint identifier and said power supply interface of said hard disk both are connected with the hard disk body through said electric controlled switch.

4. A fingerprint hard disk according to claim 1, wherein said hard disk control device is a electric controlled switch; and said hard disk further comprises a power supply interface and a signal interface; wherein said control interface of said fingerprint identifier and said power supply interface of said hard disk both are connected with the hard disk body through said electric controlled switch.

5. A fingerprint hard disk according to claim 1, wherein said hard disk control device is a electric controlled switch; and said hard disk body further comprises a disk cavity and a control board; wherein said disk cavity is connected with the control board through a magnetic head signal wire, a step motor control wire, and a rotary motor control wire; said control interface of the fingerprint identifier is connected to said magnetic head signal wire through said electric controlled switch.

6. A fingerprint hard disk according to claim 1, wherein said hard disk control device is a electric controlled switch; and said hard disk body further comprises a disk cavity and a control board; wherein said disk cavity is connected with the control board through a magnetic head signal wire, a step motor control wire, and a rotary motor control wire; said control interface of the fingerprint identifier is connected to said step motor control wire through said electric controlled switch.

7. A fingerprint hard disk according to claim 1, wherein said hard disk control device is a electric controlled switch; and said hard disk body further comprises a disk cavity and a control board; wherein said disk cavity is connected with the control board through a magnetic head signal wire, a step motor control wire, and a rotation motor control wire; said control interface of the fingerprint identifier is connected to said rotation motor control wire through said electric controlled switch.

8. A fingerprint hard disk according to claim 1, wherein a control board is placed respectively inside each of said fingerprint identifier and said hard disk, and a microprecessor, a interface circuit, and a RAM are shared commonly by both control board; and whether to enable the hard disk control procedure running by the hard disk control device is determined by the fingerprint identification procedure implemented by the fingerprint identifier on the basis of the identification result, or whether to enable the operation of the hard disk will be determined by the hard disk control procedure operated by the hard disk control device on the basis of the decision result of the fingerprint identification procedure.

9. A fingerprint hard disk according to claim 3, wherein said electric controlled switch is a relay or an electronic switch.

10. A fingerprint hard disk according to claim 4, wherein said electric controlled switch is a relay or an electronic switch.

11. A fingerprint hard disk according to claim 5, wherein said electric controlled switch is a relay or an electronic switch.

12. A fingerprint hard disk according to claim 6, wherein said electric controlled switch is a relay or an electronic switch.

13. A fingerprint hard disk according to claim 7, wherein said electric controlled switch is a relay or an electronic switch.

14. A fingerprint hard disk according to claim 1, wherein said hard disk is a portable hard disk, a flash disk, a Zip drive disk or other storage devices.
